(19) United States
(12) Patent Application Publication
(10) Pub. No.: US 2024/0219279 A1
(43) Pub. Date: Jul. 4, 2024

(54) TESTING APPARATUS FOR FRICTION AND WEAR

(71) Applicant: TSINGHUA UNIVERSITY, Beijing (CN)

(72) Inventors: Ying LIU, Beijing (CN); Haoran LIAO, Beijing (CN); Zhurong LIANG, Beijing (CN); Anqi HUANG, Beijing (CN); Hongju LI, Beijing (CN); Xiang ZHAO, Beijing (CN); Weifeng HUANG, Beijing (CN); Yongjian LI, Beijing (CN); Fei GUO, Beijing (CN)

(21) Appl. No.: 18/605,862

(22) Filed: Mar. 15, 2024

Related U.S. Application Data
(63) Continuation of application No. PCT/CN2023/115786, filed on Aug. 30, 2023.

(30) Foreign Application Priority Data
Sep. 9, 2022 (CN) 202211102194.7

(51) Int. Cl. G01N 3/56; G01M 13/00; G01N 3/02

(52) U.S. Cl. CPC G01N 3/56; G01M 13/00; G01N 3/02

(57) ABSTRACT

Provided is a testing apparatus for friction and wear, which includes a testing mechanism, a controller, a lubrication system, a cooling system, a loading system, and a detection system. The controller is communicatively connected to the testing mechanism. The lubrication system is adapted to be in communication with the testing mechanism and communicatively connected to the controller. The cooling system is adapted to be in communication with the testing mechanism. The loading system is adapted to be in communication with the testing mechanism and communicatively connected to the controller. The detection system is adapted to be connected to the testing mechanism and communicatively connected to the controller.

### CROSS-REFERENCE TO RELATED APPLICATION

This application is a continuation of International Application No. PCT/CN2023/115786, filed on Aug. 30, 2023, which is submitted based on and claims priority to Chinese patent application Ser. No. 20/221,1102194.7, filed on Sep. 9, 2022, the entire disclosure of which is incorporated herein by reference.

### FIELD

The present disclosure relates to the field of rotary apparatus testing, and more particularly, to a testing apparatus for friction and wear.

### BACKGROUND

With the development of science and technology, basic research equipment may be used to simulate an actual operating condition to carry out performance research and testing of some key components in a rotary apparatus.

In the related art, with the development of the rotary apparatus towards higher performance indicators, the basic research equipment for friction and wear performance research are required to operate at a linear speed up to 200 m/s, a temperature up to 200° C. and an axial load of tens of thousands of newtons. A harsh operating condition readily leads to failure of a bearing due to the high speed, the high load, and the high temperature. This can affect accuracy of testing measurement data, and can lead to destruction of the equipment even in severe case.

A friction and wear test system in the related art is highly prone to failure under a heavy load operating condition and has a complex structure design and low reliability and stability.

### SUMMARY

The present disclosure aims to solve at least one of the technical problems in the related art. Embodiments of the present disclosure is to provide a testing apparatus for friction and wear. This testing apparatus is user-friendly, and has a simple structure, high stability and reliability.

A testing apparatus for friction and wear according to an embodiment of the present disclosure includes a testing mechanism, a controller, a lubrication system, a cooling system, a loading system, and a detection system. The testing mechanism is configured to simulate a testing operating condition. The controller is communicatively connected to the testing mechanism and configured to send a first drive signal to the testing mechanism to allow the testing mechanism to simulate the testing operating condition. The lubrication system is adapted to be in communication with the testing mechanism and communicatively connected to the controller, and the controller is configured to send a second drive signal to the lubrication system to allow the lubrication system to deliver a lubrication medium to the testing mechanism. The cooling system is adapted to be in communication with the testing mechanism and communicatively connected to the controller, and the controller is configured to send a third drive signal to the cooling system to allow the cooling system to deliver a cooling medium to the testing mechanism. The loading system is adapted to be in communication with the testing mechanism and communicatively connected to the controller, and the controller is configured to send a fourth drive signal to the loading system to allow the loading system to apply an axial load to the testing mechanism. The detection system is adapted to be connected to the testing mechanism and communicatively connected to the controller, and the detection system is configured to detect testing information on the testing mechanism and sending the testing information to the controller.

With the testing apparatus for the friction and wear according to the embodiment of the present disclosure, the testing mechanism is provided to simulate a high-speed operating condition. By providing the lubrication system and communicating the lubrication system and the testing mechanism, the lubrication medium for lubricating and cooling can be delivered to the testing mechanism by the lubrication system to improve stability and the reliability of the testing mechanism. By arranging the cooling system and communicating the cooling system and the testing mechanism, the cooling medium for cooling can be delivered to the testing mechanism by the cooling system to rapidly cool the testing mechanism. Thus, the stability and reliability of the testing mechanism can be further improved. By arranging the loading system and communicating the loading system and the testing mechanism, axial loads of equal magnitude and opposite directions can be applied to opposite ends of the testing mechanism in the axial direction of the testing mechanism respectively. Thus, a heavy-load operating condition can be simulated. By arranging the detection system and connecting the detection system to the testing mechanism, a plurality of pieces of testing information inside the testing mechanism can be detected in real time. In addition, the testing apparatus for the friction and wear according to the embodiment of the disclosure is user-friendly, and has a simple structure, high stability and better reliability.

In some examples of the present disclosure, the testing mechanism includes a support device, a chamber device, a cooling device, a drive device, and a balance device. The support device has an end connected to the support device, and the support device is configured to drive the chamber device to move in an axial direction of the chamber device.

The cooling device has an end connected to another end of the chamber device. The drive device has an end connected to another end of the cooling device. Further, the drive device has a rotary shaft that penetrates the cooling device and is connected to a movable ring of the chamber device. The cooling device is configured to cool the rotary shaft. The balance device is connected to the rotary shaft and in communication with the loading system, and the loading system is configured to apply an axial load to the rotary shaft by the balance device.

In some examples of the present disclosure, the support device includes a support base and a support frame. The support frame includes a first support portion, a second support portion, and a connection portion. The first support portion is fixedly connected to the second support portion by the connection portion. The first support portion has a side fixedly connected to the support base and another side connected to the chamber device. The second support portion is fixedly connected to the drive device.

In some examples of the present disclosure, the support device further includes a slider movably arranged around an outer side wall of the connection portion and fixedly connected to the chamber device. The chamber device is movably connected to the connection portion by the slider.

In some examples of the present disclosure, the support device further includes a lift mechanism and a support member. The lift mechanism is connected between the chamber device and the first support portion and configured to drive the chamber device to move in an axial direction of the connection portion. The support member is disposed between the chamber device and the first support portion and configured to support the chamber device.

In some examples of the present disclosure, the chamber device includes a chamber body and a chamber tray. The chamber tray is connected between the chamber body and the lift mechanism and fixedly connected to the slider.

In some examples of the present disclosure, the lubrication system includes a first sub-lubrication system and a second sub-lubrication system. Each of the first sub-lubrication system and the second sub-lubrication system is communicatively connected to the controller. The first sub-lubrication system is in communication with the drive device and configured to deliver the lubrication medium to the drive device. The second sub-lubrication system is in communication with the chamber device and configured to deliver the lubrication medium to the chamber device.

In some examples of the present disclosure, the first sub-lubrication system includes a first compression member, a first storage member, and a first lubrication device sequentially in communication with each other. The first compression member is communicatively connected to the controller. The first lubrication device has a medium outlet in communication with a lubrication medium inlet of the drive device. The first compression member is configured to drive the lubrication medium in the first lubrication device to flow into the drive device.

In some examples of the present disclosure, the second sub-lubrication system includes a second compression member, a second storage member, and a second lubrication device sequentially in communication with each other. The second compression member is communicatively connected to the controller. The second lubrication device has a medium outlet in communication with a lubrication medium inlet of the chamber device. The second compression member is configured to drive the lubrication medium in the second lubrication device to flow into the chamber device.

In some examples of the present disclosure, the second sub-lubrication system further includes a heating element disposed between the medium outlet of the second lubrication device and the lubrication medium inlet of the chamber device, and the heating element is configured to heat the lubrication medium.

In some examples of the present disclosure, the second sub-lubrication system further includes a filter member disposed between a medium inlet of the second lubrication device and a lubrication medium outlet of the chamber device, and the filter member is configured to filter the lubrication medium.

In some examples of the present disclosure, the cooling system includes a first sub-cooling system and a second sub-cooling system. Each of the first sub-cooling system and the second sub-cooling system is communicatively connected to the controller, and the first sub-cooling system is connected to the second sub-cooling system for heat exchange. The first sub-cooling system is in communication with the cooling device and configured to deliver the cooling medium to the cooling device. The second sub-cooling system is in communication with the drive device and configured to deliver the cooling medium to the cooling device.

In some examples of the present disclosure, the first sub-cooling system includes a first pump and a first circulation cooling member. The first pump is communicatively connected to the controller, and the first pump is in communication with the first circulation cooling member and a cooling medium outlet of the cooling device. The first circulation cooling member is in communication with a cooling medium inlet of the cooling device.

In some examples of the present disclosure, the second sub-cooling system includes a second pump and a second circulation cooling member. The second pump body, the first circulation cooling member, and the second circulation cooling member are sequentially in communication with each other to form a closed-loop flow path. The second circulation cooling member is in communication with each of the cooling medium inlet and the cooling medium outlet of the drive device.

In some examples of the present disclosure, the loading system includes a third compression member and a third storage member. The third compression member is communicatively connected to the controller and in communication with the third storage member; and the third storage member is in communication with each of the balance device and the chamber device, and the third compression member is adapted to apply an axial load to each of the balance device and the chamber device.

In some examples of the present disclosure, the detection system is connected to each of the drive device, the chamber device, and the support device. The detection system is configured to detect a vibration signal, a temperature signal, a friction force signal, an acceleration signal, a displacement signal, and a force signal of the testing mechanism, and send the detected vibration signal, the detected temperature signal, the detected friction force signal, the detected acceleration signal, the detected displacement signal and the detected force signal to the controller.

Additional aspects and advantages of the embodiments of present disclosure will be provided at least in part in the following description, or will become apparent in part from the following description, or can be learned from the practice of the embodiments of the present disclosure.

### BRIEF DESCRIPTION OF THE DRAWINGS

FIG. 1 is a schematic structural view of a testing apparatus according to an embodiment of the present disclosure.

FIG. 2 is a schematic structural view of a testing mechanism according to an embodiment of the present disclosure.

FIG. 3 is a schematic view of a connection between a support device and a chamber tray according to an embodiment of the present disclosure.

FIG. 4 is a schematic structural view of a chamber device according to an embodiment of the present disclosure.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

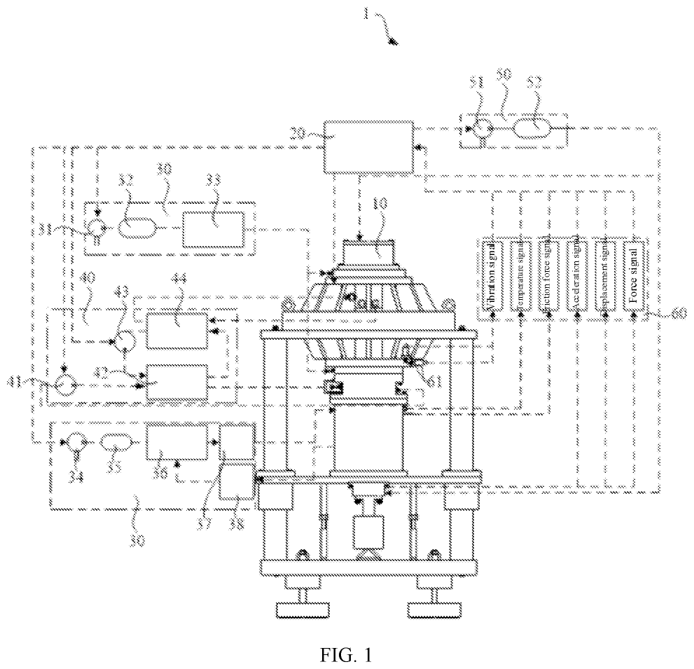

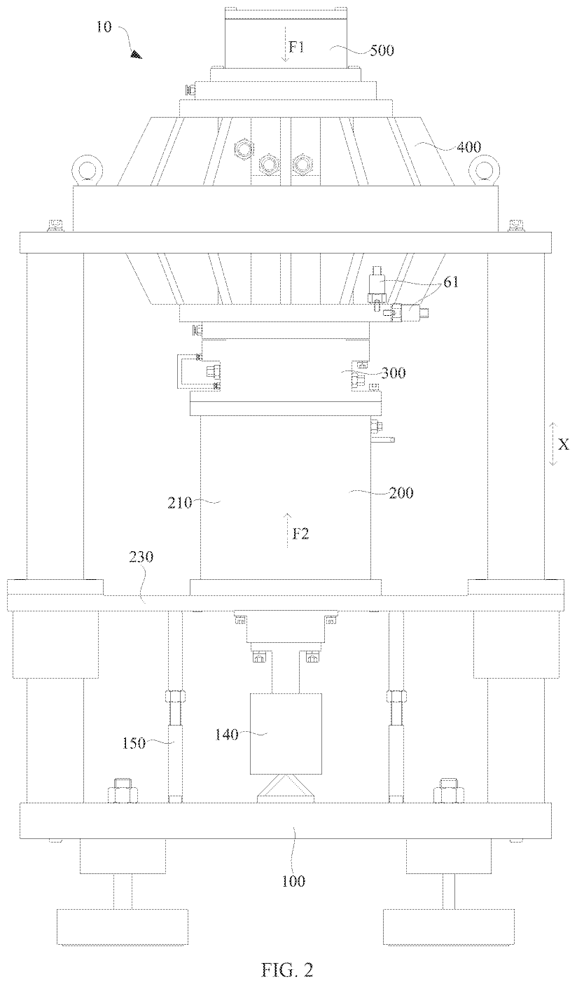

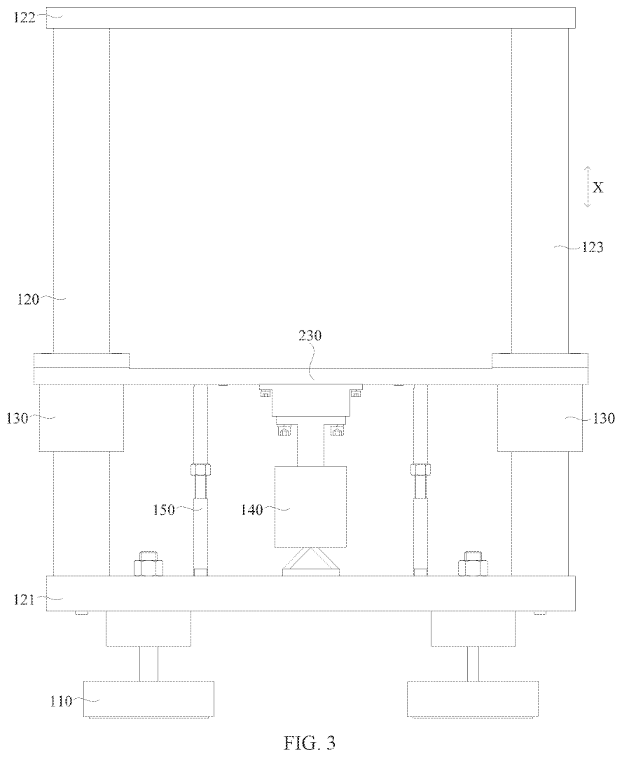

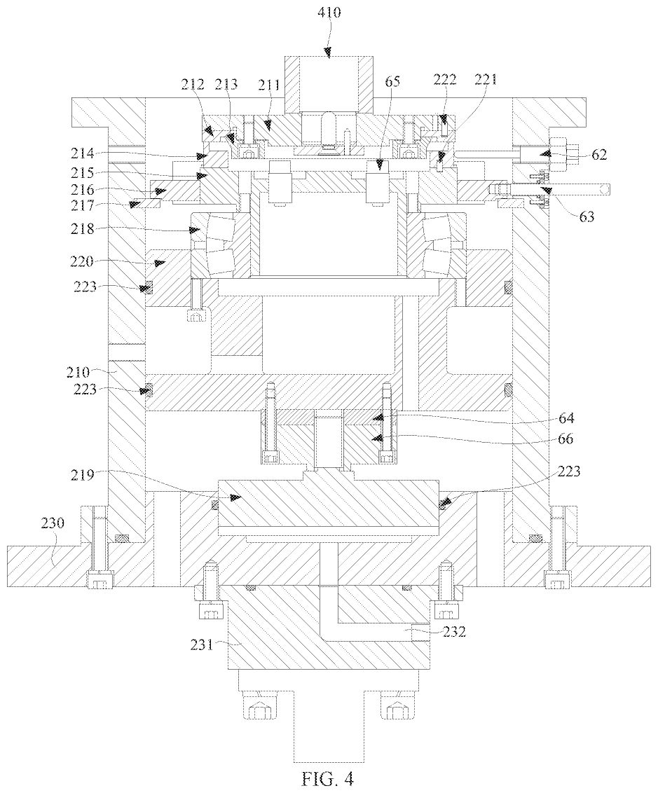

FIG. 1 is a schematic structural view of a testing apparatus 1 according to an embodiment of the present disclosure, FIG. 2 is a schematic structural view of a testing mechanism 10 according to an embodiment of the present disclosure, FIG. 3 is a schematic view of a connection between a support device 100 and a chamber tray 230 according to an embodiment of the present disclosure, and FIG. 4 is a schematic structural view of a chamber device 200 according to an embodiment of the present disclosure. A testing apparatus 1 for friction and wear according to an embodiment of the present disclosure will be described below with reference to FIGS. 1 to 4. The testing apparatus 1 includes a testing mechanism 10, a controller 20, a lubrication system 30, a cooling system 40, a loading system 50, and a detection system 60. The testing mechanism 10 is configured to simulate a testing operating condition. The controller 20 is communicatively connected to the testing mechanism 10 and configured to send a first drive signal to the testing mechanism 10 to allow the testing mechanism 10 to simulate the testing operating condition. The lubrication system 30 is adapted to be in communication with the testing mechanism 10 and is communicatively connected to the controller 20 that is configured to send a second drive signal to the lubrication system 30 to allow the lubrication system 30 to deliver a lubrication medium to the testing mechanism 10. The cooling system 40 is adapted to be in communication with testing mechanism 10 and communicatively connected to controller 20, and the controller 20 is configured to send a third drive signal to the cooling system 40 to allow the cooling system 40 to deliver a cooling medium to the testing mechanism 10. The loading system 50 is adapted to be in communication with the testing mechanism 10 and communicatively connected to the controller 20, and the controller 20 is configured to send a fourth drive signal to the loading system 50 to allow the loading system 50 to apply an axial load to the testing mechanism 10. The detection system 60 is adapted to be connected to the testing mechanism 10 and communicatively connected to the controller 20. The detection system 60 is configured to detect testing information on the testing mechanism 10 and sends the testing information to the controller 20.

In an exemplary embodiment of the present disclosure, the testing apparatus 1 for friction and wear according to the embodiments of the present disclosure can simulate an actual operating condition, and therefore friction and wear performance research and testing can be carried out on some key components in a rotary apparatus inside the testing apparatus 1. For example, the testing mechanism 10 can simulate an operating condition of a high speed, a high temperature, or a heavy load. The controller 20 may be a data control center of the testing apparatus 1, and a user may control an operating state of the testing apparatus 1 through the controller 20, or may read relevant testing information on the testing apparatus 1 through the controller 20. The controller 20 may be electrically connected to the testing mechanism 10 and send a first drive signal to the testing mechanism 10 to drive the rotary apparatus inside the testing mechanism 10 to rotate.

The lubrication system 30 may provide different lubrication media, such as water, oil, high-pressure gas, which is not limited in the embodiments of the present disclosure. The lubrication system 30 may be electrically connected to the controller 20, and the controller 20 may send a second drive signal to the lubrication system 30 to deliver a lubrication medium to an interior of the testing mechanism 10, allowing the lubrication medium to flow to the interior of the testing mechanism 10 from the lubrication system 30. The lubrication medium may be lubrication oil contained inside the lubrication system 30. With this arrangement, the lubrication medium can serve to mitigate wear of the rotary apparatus inside the testing mechanism 10 while also cooling the rotary apparatus.

The cooling system 40 may provide various cooling such as low-temperature water cooling or low-temperature oil cooling, which is not limited in the embodiments of the present disclosure. The cooling system 40 may be electrically connected to the controller 20, and the controller 20 may send a third drive signal to the cooling system 40 to deliver a cooling medium to the interior of the testing mechanism 10, allowing a circular flow of the cooling medium inside the testing mechanism 10. The cooling medium may be cooling water or cooling oil contained inside the cooling system 40. With this arrangement, heat generated inside the testing mechanism 10 can be absorbed and carried away by the cooling medium, thereby rapidly cooling the testing mechanism 10. Therefore, stability and reliability of the testing mechanism 10 can be effectively improved.

The loading system 50 may be electrically connected to the controller 20, and the controller 20 may send a fourth drive signal to the loading system 50 to apply an axial load to the testing mechanism 10, allowing the testing mechanism 10 to simulate a heavy-load operating condition. It should be noted that the loading system 50 can apply axial loads (such as axial forces F1 and F2 in FIG. 2) of equal magnitude and opposite directions on opposite ends of the testing mechanism 10 in an axial direction of the testing mechanism 10 respectively, and the axial direction of the testing mechanism 10 may be a direction indicated by X in FIG. 2. With this arrangement, the loading system 50 can provide the heavy-load operating condition for the testing mechanism 10.

The detection system 60 may be connected to the testing mechanism 10, and the detection system 60 may detect a plurality of pieces of testing information inside the testing mechanism 10 in real time. The detection system 60 may also be connected to the controller 20, and the plurality of pieces of detected testing information can be sent to the controller 20 by means of this arrangement. As a result, the user can obtain specific testing information at any time through the controller 20. It should be noted that the testing information may be a vibration signal, a temperature signal, a friction force signal, an acceleration signal, a displacement signal, a force signal, etc., which is not limited in the embodiments of the present disclosure.

According to the testing apparatus 1 for the friction and wear according to the embodiments of the present disclosure, the testing mechanism 10 is arranged to simulate the high-speed operating condition. By arranging the lubrication system 30 and communicate the lubrication system 30 and the testing mechanism 10, the lubrication medium for lubricating and cooling the testing mechanism 10 can be delivered by the lubrication system 30, and thus the stability and the reliability of the testing mechanism 10 can be improved. By arranging the cooling system 40 and communicate the cooling system 40 and the testing mechanism 10, the cooling medium for cooling the testing mechanism 10 can be delivered by the cooling system 40 to rapidly cool the testing mechanism 10. Thus, the stability and reliability of the testing mechanism 10 can be further improved. By arranging the loading system 50 and communicate the loading system 50 and the testing mechanism 10, the axial loads of the equal magnitude and the opposite directions can be applied to the opposite ends of the testing mechanism 10 in the axial direction of the testing mechanism 10 respectively. Thus, the heavy-load operating condition can be simulated. By arranging the detection system 60 to be connected to the testing mechanism 10, the plurality of pieces of testing information inside the testing mechanism 10 can be detected in real time. In addition, the testing apparatus 1 for the friction and wear according to the embodiments of the disclosure is user-friendly, and has a simple structure, high stability, and the better reliability.

With reference to FIGS. 2 to 4, in some embodiments of the present disclosure, the testing mechanism 10 includes a support device 100, a chamber device 200, a cooling device 300, a drive device 400, and a balance device 500. The chamber device 200 has an end connected to the support device 100, and the support device 100 is configured to drive the chamber device 200 to move in an axial direction of the chamber device 200. The cooling device 300 has an end connected to another end of the chamber device 200. The drive device 400 has an end connected to another end of cooling device 300. Further, the drive device has a rotary shaft 410 that penetrates the cooling device 300 and is connected to a movable ring 212 of the chamber device 200. The cooling device 300 is configured to cool the rotary shaft 410. The balance device 500 is connected to the rotary shaft 410 and in communication with the loading system 50. The loading system 50 is configured to apply an axial load to the rotary shaft 410 through the balance device 500.

In an exemplary embodiment of the present disclosure, the support device 100 may have a rectangular-shaped frame structure, a height direction of the support device 100 may be a direction indicated by X in FIG. 3, and an axial direction of each of the chamber device 200, the cooling device 300, the drive device 400, and the balance device 500 is parallel to the height direction of the support device 100. The support device 100 may have, in the height direction of the support device 100, an upper end fixedly connected to the drive device 400 and a lower end fixedly connected to the chamber device 200. The cooling device 300 is disposed between the drive device 400 and the chamber device 200. The balance device 500 is disposed at an end of the drive device 400 facing away from the cooling device 300.

Further, with continued reference to FIGS. 2 and 3, the support device 100 can drive the chamber device 200 upwards or downwards in the height direction of the support device 100, and therefore the chamber device 200 can be connected to or disconnected from the cooling device 300. The chamber device 200 can be connected to the cooling device 300 through a screw thread fit, and therefore the user can easily repair or replace a component inside the chamber device 200 with this arrangement. The interior of the chamber device 200 can serve for mounting of some rotary apparatuses configured to simulate the friction and wear operating condition. The drive device 400 may be a double shaft-extension motor, and two ends of the drive device 400 in an axial direction of the drive device 400 may be provided with two rotary shafts 410 respectively. Each of the two rotary shafts 410 may extend out of the drive device 400. One of the two rotary shafts 410 may penetrate the cooling device 300 and be drivingly connected to the movable ring 212 inside the chamber device 200, and therefore the movable ring 212 inside the chamber device 200 can be driven to rotate by the drive device 400. The other one of the two rotary shafts 410 may be inserted into the balance device 500 via an end of the balance device 500, and another end of the balance device 500 facing away from the drive device 400 may be in communication with the loading system 50.

The loading system 50 may apply a high-pressure gas to the balance device 500, and a pressure of the high-pressure gas may be converted, inside the balance device 500, into an axial force acting on the rotary shaft 410. This axial force may be transferred to the movable ring 212 inside chamber device 200 by the rotary shaft 410.

With continued reference to FIG. 2, the cooling device 300 may be arranged around an outer sidewall of the rotary shaft 410, and the cooling device 300 may be in communication with the cooling system 40 to form a closed-loop flow path along which the cooling medium flows. The cooling medium in the cooling system 40 may flow into the cooling device 300 through a cooling medium inlet of the cooling device 300, and then may flow out of the cooling device 300 through a cooling medium outlet of the cooling device 300 and into the cooling system 40. With this arrangement, the cooling medium can serve to absorb and carry away heat from the rotary shaft 410 and thus can cool the rotary shaft 410.

Therefore, stable operation of the rotary shaft 410 can be ensured.

With continued reference FIGS. 2 and 3, in some embodiments of the present disclosure, the support device 100 includes a support base 110 and a support frame 120. The support frame 120 includes a first support portion 121, a second support portion 122, and a connection portion 123. The first support portion 121 is fixedly connected to the second support portion 122 by the connection portion 123. The first support portion 121 has a side fixedly connected to the support base 110 and the other side of the first support portion 121 connected to the chamber device 200. The second support portion 122 is fixedly connected to the drive device 400.

In an exemplary embodiment of the present disclosure, a plurality of support bases 110 (e.g., four support bases) may be provided and may be fixedly connected to the support frame 120 in a threaded connection manner. With this arrangement, vibration amplitude of the support frame 120 can be effectively reduced by the support base 110, and vibration loss of the whole testing apparatus 1 is thus reduced.

A plurality of the connection portions 123 may be provided (e.g., four connection portions), and an axial direction of each connection portion 123 may be parallel to the height direction of the support device 100. The first support portion 121 and the second support portion 122 may be fixedly connected to opposite ends of the connection portion 123 in the axial direction of the connection portion 123 respectively through welding, threaded connection, or integrated connection, which is not limited in the embodiments of the present disclosure.

Further, the first support portion 121 may have a side fixedly connected to the support base 110 and the other side fixedly connected to the chamber device 200, and the chamber device 200 may be slidably connected to the connection portion 123. With this arrangement, the chamber device 200 can easily move in an axial direction of the connection portion 123. The second support portion 122 may be fixedly connected to the drive device 400 through welding, snapping, or threaded connection. With this arrangement, the drive device 400 can be fixed and supported by the second support portion 122.

With continued reference to FIGS. 2 and 3, in some embodiments of the present disclosure, the support device 100 further includes a slider 130 movably arranged around an outer wall of the connection portion 123 and fixedly connected to the chamber device 200.

The chamber device 200 is movably connected to the connection portion 123 by the slider 130.

In an exemplary embodiment of the present disclosure, the slider 130 may be a linear bearing, and the number of the sliders 130 may be the same as the number of the connection portions 123. Further, an axial direction of the slider 130 may be parallel to the axial direction of the connection portion 123. In addition, the slider 130 may be arranged around an outer side wall of the connection portion 123, and the slider 130 may be fixedly connected to the chamber device 200. With this arrangement, the chamber device 200 can move in the axial direction of the connection portion 123.

With continued reference to FIGS. 2 and 3, in some embodiments of the present disclosure, the support device 100 further includes a lift mechanism 140 and a support member 150. The lift mechanism 140 is connected between the chamber device 200 and the first support portion 121 and configured to drive the chamber device 200 to move in an axial direction of the connection portion 123. The support member 150 is disposed between the chamber device 200 and the first support portion 121 and configured to support the chamber device 200.

In an exemplary embodiment of the present disclosure, the lift mechanism 140 may be a motor, a cylinder, or a worm gear. The lift mechanism 140 may be disposed between the first support portion 121 and the chamber device 200. The lift mechanism 140 may have an end fixedly connected to the chamber device 200 in the threaded connection manner and the other end fixedly connected to the first support portion 121 through welding, threaded connection, riveting, etc. With this arrangement, the lift mechanism 140 can drive the chamber device 200 to move in the axial direction of the connection portion 123. For example, the lift mechanism 140 can be controlled electrically or manually to drive the chamber device 200 downwards, and therefore the user can easily repair or replace the component inside the chamber device 200. After the replacement is completed, the lift mechanism 140 can be controlled electrically or manually to drive the chamber device 200 upwards to be connected to the cooling device 300.

Further, a plurality of support members 150 (e.g., four support members) may be provided, and each support member 150 may be a rotary rod having threads, and thus the user may manually rotate the support member 150 to extend the support member 150 and support the support member 150 between the chamber device 200 and the first support portion 121.

With this arrangement, the support member 150 can improve support strength between the first support portion 121 and the chamber device 200, thereby improving stability of the chamber device 200.

With continued reference to FIGS. 2 and 4, in some embodiments of the present disclosure, the chamber device 200 includes a chamber body 210 and a chamber tray 230. The chamber tray 230 is connected between the chamber body 210 and the lift mechanism 140 and fixedly connected to the slider 130.

In an exemplary embodiment of the present disclosure, the chamber tray 230 may be fixedly connected to an end of the chamber body 210 in the threaded connection manner, and the chamber tray 230 is configured to fix and support the chamber body 210. The chamber tray 230 is also fixedly connected to the slider 130 through welding, threaded connection, or the like. With this arrangement, the chamber body 210 can be movably connected to the connection portion 123.

Further, with continued reference to FIG. 4, the chamber body 210 may be connected between the cooling device 300 and the chamber tray 230 in the threaded manner.

The interior of the chamber body 210 may be provided with a movable ring seat 211, a movable ring 212, a movable ring cover 213, a stationary ring 214, a stationary ring seat 215, a mounting plate 216, a limit member 217, a self-aligning bearing 218, a carrier plate 219, a force sensor 66, an acceleration sensor 64, a bearing seat 220, a friction force sensor 63, a temperature sensor 62, a stationary ring pin 221, a displacement sensor 65, a movable ring pin 222.

The movable ring 212 is fixedly connected to an end of the movable ring seat 211 by the movable ring cover 213, and a movable ring pin 222 may be disposed between the movable ring 212 and the movable ring seat 211 and configured to transfer torque. The other end of the movable ring seat 211 facing away from the movable ring 212 can drive a transmission connection of the rotary shaft 410 of the drive device 400. With this arrangement, the axial load applied by the loading system 50 can be easily transferred to the movable ring 212 through the rotary shaft 410. Meanwhile, the rotary shaft 410 can drive the movable ring 212 to rotate relative to the stationary ring 214, allowing for a sliding friction state between the movable ring 212 and the stationary ring 214. The other end of the movable ring 212 facing away from the movable ring seat 211 is in direct contact with an end of the stationary ring 214, and a contact surface between the movable ring 212 and the movable ring seat 211 is referred to as a contact end surface. Each of the movable ring 212 and the stationary ring 214 may be of an annular-shaped structure. In this embodiment, the movable ring cover 213 may be inserted inside the stationary ring 214, and no interference would occur between the movable ring cover 213 and the stationary ring 214. The other end of the stationary ring 214 facing away from the movable ring 212 is connected to the stationary ring seat 215, and therefore an axial position of the movable ring 212 can be restricted by the stationary ring seat 215. A contact surface between the stationary ring 214 and the stationary ring seat 215 is provided with a stationary ring pin 221. The stationary ring pin 221 is configured to transfer friction torque between the movable ring 212 and the stationary ring 214. A mounting hole (not shown) may be defined in a middle part of the stationary ring seat 215. The mounting hole may have a size and a shape matching a size and a shape of the stationary ring 214, and therefore the stationary ring 214 may be fixedly mounted in the mounting hole. In addition, an inner wall of the mounting hole and an outer wall of the stationary ring 214 may have an interference fit relationship. With this arrangement, radial displacement of the stationary ring 214 can be effectively restricted.

With continued reference to FIG. 4, the mounting hole of the stationary ring seat 215 may have a plurality of threaded through holes (not shown) for threaded mounting of the displacement sensor 65, and the displacement sensor 65 is electrically connected to the controller. With this arrangement, wear loss between the movable ring 212 and the stationary ring 214 may be initially measured by the displacement sensor 65 to form a displacement signal, and the displacement signal can be transferred to the controller 20. Therefore, contact between the movable ring cover 213 and the stationary ring seat 215 due to excessive wear can be avoided. In this embodiment, a counterbore (not shown) may surround the threaded through hole. With this arrangement, interference of a metal around the displacement sensor 65 on a measurement result of the displacement sensor 65 can be avoided, thereby improving detection accuracy of the displacement sensor 65. Another end of the stationary ring seat 215 facing away from the stationary ring 214 may be formed into a cylindrical-shaped structure. With this arrangement, quick disassembly and assembly of the displacement sensor 65 is facilitated.

With continued reference to FIG. 4, in the embodiments of the present disclosure, the stationary ring seat 215 may abut with a mounting plate 216 in a circumferential direction of the stationary ring seat 215, and the stationary ring seat 215 may be movably connected to the mounting plate 216 by a spline or a gear. With this arrangement, a position of the mounting plate 216 relative to the chamber body 210 cannot be changed after the stationary ring 214 is worn. The stationary ring seat 215 can totally move upwards due to wear, which can simultaneously ensure that force transmission between the stationary ring seat 215 and the mounting plate 216 is not affected. The friction force sensor 63 may be disposed at the mounting plate 216. The friction force sensor 63 may be fixedly connected to the mounting plate 216 in a threaded manner and electrically connected to the controller 20. A friction force generated by friction between contact end surface between the movable ring 212 and the stationary ring 214 can be transferred to the stationary ring seat 215 through the stationary ring pin 221, and then transferred to the mounting plate 216 through the stationary ring seat 215, and finally measured by the friction force sensor 63 to obtain a friction characteristic parameter, thereby forming a friction force signal. The friction force signal is sent to the controller 20. The mounting plate 216 may be placed on a limit member 217, and the limit member 217 may be fixedly disposed inside the chamber body 210. With this arrangement, the limit member 217 can restrict the mounting plate 216 to move downwards. In this embodiment, the limit member 217 may be inserted into an inner side wall of the chamber body 210 by means of a split structure.

With continued reference to FIG. 4, in the embodiments of the present disclosure, an end surface of the stationary ring seat 215 facing away from the stationary ring 214 may be inserted into an inner race of a self-aligning bearing 218, and therefore the stationary ring seat 215 can swing along with the inner race of the self-aligning bearing 218. A contact surface between an inner race end portion of the self-aligning bearing 218 and the stationary ring seat 215 may have a jacking threaded hole (not shown), and therefore the self-aligning bearing 218 can be easily disassembled and assembled. The self-aligning bearing 218 may be a self-aligning ball bearing, a self-aligning roller bearing, a self-aligning thrust bearing, etc., which is not limited in the embodiments of the present disclosure. During an exemplary operation, a testing load can be transferred to an outer race of the self-aligning bearing 218 through the bearing seat 220, and therefore the inner race and the outer race of the self-aligning bearing 218 have a relative displacement trend. Since the inner race of the self-aligning bearing 218 is restrained from moving by the stationary ring seat 215, the inner race of the self-aligning bearing 218 and the stationary ring seat 215 together generate a same force as the testing load, and this force can be transferred to the stationary ring 214 from the stationary ring seat 215 and act on the movable ring 212, and finally apply the load. Since the self-aligning bearing 218 has a function of self-alignment, the stationary ring seat 215 can swing along with the inner race of the self-aligning bearing 218. This can effectively solve a problem of uneven contact end surfaces between the movable ring 212 and the stationary ring 214 in a processing and mounting process and effectively improve accuracy, repeatability, and reliability of friction characteristic measurement of the material.

With continued reference to FIG. 4, in the embodiments of the present disclosure, the outer race of the self-aligning bearing 218 is mounted on the bearing seat 220, a gap is defined between the bearing seat 220 and the inner side wall of the chamber body 210, and the bearing seat 220 is provided with O-shaped seal rings 223 mounted at an upper side and a lower side of the outer race of the bearing seat 220 respectively, and therefore the bearing seat 220 has good coaxiality while retaining floatability. The bearing seat 220 may have symmetrical bearing mounting screw holes (not shown), symmetrical sensor wiring holes (not shown), and symmetrical lubrication oil circulation holes (not shown). The force sensor 66 may be mounted at an end of the bearing seat 220 facing away from the self-aligning bearing 218 in the treaded manner, and the acceleration sensor 64 may be mounted between the force sensor 66 and the bearing seat 220. Each of the force sensor 66 and the acceleration sensor 64 is electrically connected to the controller 20. The force sensor 66 and the acceleration sensor 64 can measure the axial force signal and the acceleration signal of the movable ring 212 respectively and send the force signal and the acceleration signal to the controller 20. A carrier plate 219 may have an end mounted at the force sensor 66 in the threaded manner and another end inserted into the chamber tray 230, and a gap may be defined between the carrier plate 219 and the chamber tray 230. An end of the chamber tray 230 facing away from the carrier plate 219 may be connected to an air guide plate 231 in the threaded manner. The air guide plate 231 has an air guide hole 232. One end of the air guide hole 232 may penetrate the chamber tray 230 to be in communication with a gap between the carrier plate 219 and the chamber tray 230, and the other end is configured to be in communication with the loading system 50. With this arrangement, the loading system 50 can easily apply the high-pressure gas to the gap between the carrier plate 219 and the chamber tray 230, and the pressure of the high-pressure gas can be converted, inside the gap between the carrier plate 219 and the chamber tray 230, into an axial force acting on the carrier plate 219. This axial force can be transferred to the bearing seat 220 through the force sensor 66, then to the self-aligning bearing 218 from the bearing seat 220, further to stationary ring seat 215 from self-aligning bearing 218, and finally to the movable ring 212 through the stationary ring 214. It should be noted that the loading system 50 can apply axial loads of same magnitude and opposite directions to the balance device 500 and the carrier plate 219. With this arrangement, the movable ring 212 can be in a state of equilibrium of two forces.

Further, with continued reference to FIG. 4, an O-shaped seal ring 223 may be provided between the chamber tray 230 and the carrier plate 219, this can seal the high-pressure gas while ensuring the floatability. The chamber body 210 may have a lubrication medium inlet (not shown) and a temperature sensor inlet (not shown) that are defied at upper end of the chamber body 210 close to the contact end surface. The chamber body 210 may have a lubrication medium outlet (not shown) defined at a lower end of the chamber body 210 close to the chamber tray 230. The lubrication system 30 may be in communication with each of the lubrication medium inlet and the lubrication medium outlet of the chamber body 210 to form a closed-loop flow path, and therefore the lubrication medium can circulate to lubricate the component inside the chamber body 210. The temperature sensor 62 may be inserted into the chamber body 210 through the temperature sensor inlet, and the temperature sensor 62 is electrically connected to the controller 20. With this arrangement, a temperature change inside the chamber body 210 can be detected by the temperature sensor 62 in time. In addition, a through hole (not shown) for mounting of the friction force sensor 63 is formed at a position where the chamber body 210 corresponds to the mounting plate 216. The friction force sensor 63 may be a force measurement rod. The force measurement rod may have an end inserted into the mounting plate 216 through the through hole and another end for being connected to the controller 20. The friction force on the mounting plate 216 can be transferred to the force measurement rod, and a friction force signal generated between the movable ring 212 and the stationary ring 214 can be obtained after a moment arm calculation.

With continued reference to FIG. 1, in some embodiments of the present disclosure, the lubrication system 30 includes a first sub-lubrication system (not shown) and a second sub-lubrication system (not shown). Each of the first sub-lubrication system and the second sub-lubrication system is communicatively connected to the controller 20. The first sub-lubrication system is in communication with the drive device 400 and configured to deliver the lubrication medium to the drive device 400. The second sub-lubrication system 30 is in communication with the chamber device 200 and configured to deliver the lubrication medium to the chamber device 200.

In an exemplary embodiment of the present disclosure, the first sub-lubrication system may be electrically connected to the controller 20. The first sub-lubrication system may be in communication with a lubrication medium inlet (not shown) of the drive device 400. The controller 20 may drive the first sub-lubrication system to operate to allow the lubrication medium inside the first sub-lubrication system to be delivered into the drive device 400. Thus, a bearing (not shown) in the drive device 400 is lubricated, and thus wear of the bearing can be reduced. The second sub-lubrication system may be electrically connected to the controller 20. The second sub-lubrication system may be in communication with each of the lubrication medium inlet and the lubrication medium outlet of the chamber body 210 to form a closed-loop flow path. The controller 20 may drive the second sub-lubrication system to operate to allow the lubrication medium in the second sub-lubrication system to be delivered into the chamber body 210. Thus, a high-temperature oil-gas lubrication environment may be formed inside the chamber body 210.

With continued reference to FIG. 1, in some embodiments of the present disclosure, the first sub-lubrication system includes a first compression system 31, a first storage member 32, and a first lubrication device 33 in communication with each other. The first compression system 31 is communicatively connected to the controller 20. The first lubrication device 33 has a medium outlet in communication with a lubrication medium inlet of the drive device 400. The first compression system 31 is configured to drive the lubrication medium in the first lubrication device 33 to flow into the drive device 400.

In an exemplary embodiment of the present disclosure, the first compression system 31 may be an air compressor, and the air compressor is configured to provide high-pressure gas. The first storage member 32 may be a high-pressure gas tank. The first lubrication device 33 may contain a lubrication medium, and the lubrication medium may be lubrication oil. The high-pressure gas tank is configured to buffer the high-pressure gas generated by the air compressor to allow for a more stable pressure of the high-pressure gas.

The high-pressure gas generated by the air compressor may be input into the first lubrication device 33 through the high-pressure gas tank. The high-pressure gas may drive a plunger pump (not shown) in the first lubrication device 33 to pump the lubrication oil. The high-pressure gas and the lubrication oil may be combined to form lubrication oil gas. The lubrication oil gas may flow into the interior of the drive device 400 through the lubrication medium inlet of the drive device 400 to lubricate the bearing in the drive device 400.

With continued reference to FIG. 1, in some embodiments of the present disclosure, the second sub-lubrication system 30 includes a second compression member 34, a second storage member 35, and a second lubrication device 36 in communication with each other. The second compression member 34 is communicatively connected to controller 20. The second lubrication device 36 has a medium outlet in communication with a lubrication medium inlet of chamber device 200. The second compression member 34 is configured to drive the lubrication medium in the second lubrication device 36 to flow into the chamber device 200.

In an exemplary embodiment of the present disclosure, the second compression member 34 may be an air compressor, and the air compressor is configured to provide high pressure gas. The second storage member 35 may be a high-pressure gas tank, and the second lubrication device 36 may contain a lubrication medium, and the lubrication medium may be lubrication oil. The medium outlet and the medium inlet of the second lubrication device 36 may be in communication with the lubrication medium outlet and the lubrication medium inlet of the chamber body 210 respectively to form a closed flow path. The high-pressure gas tank is configured to buffer the high-pressure gas generated by the air compressor to allow for a more stable pressure of the high-pressure gas. The high-pressure gas generated by the air compressor may be input into the second lubrication device 36 through the high pressure gas tank, and the high-pressure gas may drive a plunger pump (not shown) in the second lubrication device 36 to pump the lubrication oil. The high-pressure gas and the lubrication oil may be combined to form lubrication oil gas, and the lubrication oil gas may flow into the chamber body 210 through the lubrication medium inlet of the chamber body 210 to form a high-temperature oil gas lubrication environment inside the chamber body 210. Meanwhile, the lubrication gas may flow out into the second lubrication device 36 through the medium outlet of the chamber body 210.

With continued reference to FIG. 1, in some embodiments of the present disclosure, the second sub-lubrication system 30 further includes a heating element 37 disposed between the medium outlet of the second lubrication device 36 and the lubrication medium inlet of the chamber device 200. The heating element 37 is configured to heat the lubrication medium.

In an exemplary embodiment of the present disclosure, the heating device 37 is configured to heat the lubrication oil gas flowing into the chamber body 210, and the lubrication oil can absorb the heat and conduct the absorbed heat into the interior of the chamber body 210 to form the high-pressure oil-gas lubrication environment inside the chamber body 210.

With continued reference to FIG. 1, in some embodiments of the present disclosure, the second sub-lubrication system 30 further includes a filter member 38 disposed between a medium inlet of the second lubrication device 36 and a lubrication medium outlet of the chamber device 200. The filter member 38 is configured to filter the lubrication medium.

In an exemplary embodiment of the present disclosure, the filter member 38 is configured to filter lubrication oil flowing out of the chamber body 210. This can effectively reduce impurities mixed in the lubrication oil gas, thereby improving purity of the lubrication oil.

With continued reference to FIG. 1, in some embodiments of the present disclosure, the cooling system 40 includes a first sub-cooling system (not shown) and a second sub-cooling system (not shown). Each of the first sub-cooling system and the second sub-cooling system is communicatively connected to the controller 20. The first sub-cooling system is connected to the second sub-cooling system for heat exchange. The first sub-cooling system 40 is in communication with the cooling device 300 and configured to deliver the cooling medium to the cooling device 300. The second sub-cooling system 40 is in communication with the drive device 400 and configured to deliver the cooling medium to the drive device 400.

In an exemplary embodiment of the present disclosure, the first sub-cooling system may be electrically connected to the controller 20. The first sub-cooling system 40 may be in communication with a cooling medium inlet (not shown) and a cooling medium outlet (not shown) of the cooling device 300. The controller 20 may drive the first sub-cooling system to operate to allow the cooling medium in the first sub-cooling system to be delivered into the cooling device 300. Therefore, the rotary shaft 410 of the drive device 400 inserted into the cooling device 300 is continuously circulated and cooled. Thus, a temperature of the rotary shaft 410 can be effectively lowered. The second sub-cooling system may be electrically connected to the controller 20. The second sub-cooling system may be in communication with each of a cooling medium inlet (not shown) and a cooling medium outlet (not shown) of the drive device 400 to form a closed-loop flow path. The controller 20 may drive the second sub-cooling system to operate to allow the cooling medium in the second sub-cooling system to be delivered into the drive device 400. Further, windings inside the drive device 400 can be cooled to ensure stability and reliability of the drive device 400.

It should be noted that the drive device 400 may have a plurality of medium inlets and a plurality of medium outlets for flowing of different media. For example, the lubrication medium inlet of the drive device 400 in communication with the lubrication system 30 is configured for circulation of the lubrication oil, and the cooling medium inlet and the cooling medium outlet of the drive device 400 in communication with the cooling system 40 are configured for circulation of cooling liquid.

With continued reference to FIG. 1, in some embodiments of the present disclosure, the first sub-cooling system includes a first pump 41 and a first circulation cooling member 42. The first pump 41 is communicatively connected to the controller 20. The first pump 41 is in communication with the first circulation cooling member 42 and a cooling medium outlet of the cooling device 300. The first circulation cooling member 42 is in communication with a cooling medium inlet of the cooling device 300.

In an exemplary embodiment of the present disclosure, the first pump 41 may be an oil pump, and the first pump 41 is configured to promote the circulation of the cooling medium. The first circulation cooling member 42 may be a cryogenic circulation oil station, and the cryogenic circulation oil station is an oil storage station having a heat exchanger that may be used with a circulating water cooler. The first circulation cooling member 42 may contain a cooling medium, and the cooling medium may be cooling oil. The oil pump can drive the cooling oil in the cryogenic circulation oil station to circulate and flow inside the cooling device 300. With this arrangement, the rotary shaft 410 inserted into the cooling device 300 can be washed by the cooling oil. Therefore, heat on the rotary shaft 410 can be absorbed and taken away. Thus, the rotary shaft 410 can be cooled to ensure the stable and reliable operation of the rotary shaft 410.

With continued reference to FIG. 1, in some embodiments of the present disclosure, the second sub-cooling system includes a second pump 43 and a second circulation cooling member 44 sequentially in communication with each other to form a closed-loop flow path. The second circulation cooling member 44 is in communication with each of the cooling medium inlet and the cooling medium outlet of the drive device 400.

In an exemplary embodiment of the present disclosure, the second pump 43 may be a water pump, and the second pump 43 is configured to promote the circulation of the cooling medium. The second circulation cooling member 44 may be a circulation water cooler having a heat exchanger structure (not shown) and a water storage station (not shown). The second circulation cooling member 44 may contain a cooling medium, and the cooling medium may be cooling water. The water pump can drive the cooling water in the circulation water cooler to circulate in the cryogenic circulation oil station. With this arrangement, the cooling water can absorb and take away the heat in the cryogenic circulation oil station. Thus, the cooling oil in the cryogenic circulating oil station is cooled.

Further, the cooling water in the circulation water cooler can circulate and flow inside the drive device 400. With this arrangement, the heat of the winding in the drive device 400 is absorbed and taken away by the cooling water. Thus, the winding is cooled to ensure the stable and reliable operation of the winding.

With continued reference to FIG. 1, in some embodiments of the present disclosure, the loading system 50 includes a third compression member 51 and a third storage member 52. The third compression member 51 is communicatively connected to the controller 20 and in communication with the third storage member 52. The third storage member 52 is in communication with each of the balance device 500 and chamber device 200. The third compression member 51 is adapted to apply an axial load to each of the balance device 500 and the chamber device 200.

In an exemplary embodiment of the present disclosure, the third compression member 51 may be an air compressor, and the air compressor is configured to provide a high-pressure gas. The third storage member 52 may be a high-pressure gas tank, and the high-pressure gas tank is configured to buffer high-pressure gas generated by the air compressor to allow for a relatively stable pressure of the high-pressure gas. The high-pressure gas tank may be in communication with each of an air inlet (not shown) of the balance device 500 and an air guide hole 232 on the air guide plate 231. The high-pressure gas generated by the air compressor may be input into each of the balance device 500 and the air guide hole 232 through the high-pressure gas tank to allow the pressure of the high-pressure gas to be applied to the balance device 500 and the carrier plate 219 connected by the air guide plate 231. The balance device 500 may transfer the axial load to the movable ring 212 through the rotary shaft 410, and the carrier plate 219 may transfer the axial load to the stationary ring 214 through the bearing seat 220, the self-aligning bearing 218, and the stationary ring seat 215, thereby providing a testing load between the movable ring 212 and the stationary ring 214.

With continued reference to FIGS. 1 to 4, in some embodiments of the present disclosure, the detection system 60 is connected to each of the drive device 400, the chamber device 200, and the support device 100. The detection system 60 is configured to detect a vibration signal, a temperature signal, a friction force signal, an acceleration signal, a displacement signal, and a force signal of the testing mechanism 10, and send the detected vibration signal, the detected temperature signal, the detected friction force signal, the detected acceleration signal, the displacement signal, and the force signal to the controller 20.

In an exemplary embodiment of the present disclosure, the detection system 60 may be electrically connected to the controller 20. The detection system 60 may include a vibration sensor 61, a temperature sensor 62, a friction sensor 6663, an acceleration sensor 64, a displacement sensor 65, and a force sensor 66. The vibration sensors 61 may be disposed at the drive device 400. Two vibration sensors 61 may be provided and arranged in a circumferential direction of the drive device 400. The vibration sensor 61 is configured to measure radial movement of the drive device 400.

The temperature sensor 62 may be disposed inside the chamber body 210. A temperature may be measured in a form of thermocouple. The temperature sensor 62 may measure the temperature of each of the contact end surfaces between the movable ring 212 and the stationary ring 214. A temperature parameter of the contact end surface is usually measured in the form of direct contact with an armored thermocouple. With this arrangement, the temperature change inside the chamber body 210 can be timely detected by the temperature sensor 62.

The friction force sensor 63 may be inserted into the chamber body 210 and configured to measure a friction force generated between the movable ring 212 and the stationary ring 214. The friction force sensor 63 has a center suspended at the side wall of the chamber body 210. The friction force sensor 63 has an end screwed into the mounting plate 216 and another end electrically connected to the controller 20. By calculating and analyzing the moment arm, the friction force generated between the movable ring 212 and the stationary ring 214 can be obtained.

The acceleration sensor 64 may be disposed between the force sensor 66 and the bearing seat 220. The acceleration sensor 64 mainly provides a protection. The movable ring 212 or the stationary ring 214 may be broken in the operating condition of the high speed, the high load, and the high temperature. In this case, the acceleration sensor 64 can measure acceleration mutation and send the data to the controller 20. As a result, a user can terminate the testing urgently to protect safety of equipment personnel.

The displacement sensor 65 may be mounted at the stationary ring seat 215 and configured for rough estimation of wear loss and an alarm. For example, when the movable ring 212 and the stationary ring 214 are worn, the stationary ring 214 and the stationary ring seat 215 move towards the drive device 400, and a distance of this movement is the wear loss. Excessive wear loss should be avoided, otherwise it would cause collision between stationary ring seat 215 and movable ring 212.

The force sensor 66 may be disposed between the carrier plate 219 and the acceleration sensor 64 and configured to measure the axial load of the testing mechanism 10.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the specific directions or are structured and performed in the specific directions, which could not to be understood to the limitation of the present disclosure.

In addition, terms such as “first” and “second” are used herein for purposes of description and are not intended to indicate or imply relative importance or significance.

Furthermore, the feature defined with “first” and “second” may comprise one or more this feature distinctly or implicitly. In the description of the present disclosure, “a plurality of” means two or more than two, unless specified otherwise.

In the present disclosure, unless specified or limited otherwise, the terms “mounted,” “connected,” “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components, which can be understood by those skilled in the art according to the detail embodiment of the present disclosure.

In the present disclosure, unless specified or limited otherwise, the first characteristic is “on” or “under” the second characteristic refers to the first characteristic and the second characteristic can be direct or via media indirect mountings, connections, and couplings. And, the first characteristic is “on”, “above”, “over” the second characteristic may refer to the first characteristic is right over the second characteristic or is diagonal above the second characteristic, or just refer to the horizontal height of the first characteristic is higher than the horizontal height of the second characteristic. The first characteristic is “below” or “under” the second characteristic may refer to the first characteristic is right over the second characteristic or is diagonal under the second characteristic, or just refer to the horizontal height of the first characteristic is lower than the horizontal height of the second characteristic.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. Without a contradiction, the different embodiments or examples and the features of the different embodiments or examples can be combined by those skilled in the art.

Although embodiments of present disclosure have been shown and described above, it should be understood that above embodiments are merely explanatory, and cannot be construed to limit the present disclosure, for those skilled in the art, changes, alternatives, and modifications can be made to the embodiments without departing from spirit, principles and scope of the present disclosure.

What is claimed is:

1. A testing apparatus for friction and wear, comprising:
a testing mechanism configured to simulate a testing operating condition;
a controller communicatively connected to the testing mechanism and configured to send a first drive signal to the testing mechanism to allow the testing mechanism to simulate the testing operating condition;
a lubrication system adapted to be in communication with the testing mechanism and communicatively connected to the controller, the controller being configured to send a second drive signal to the lubrication system to allow the lubrication system to deliver a lubrication medium to the testing mechanism;
a cooling system adapted to be in communication with the testing mechanism and communicatively connected to the controller, the controller being configured to send a third drive signal to the cooling system to allow the cooling system to deliver a cooling medium to the testing mechanism;
a loading system adapted to be in communication with the testing mechanism and communicatively connected to the controller, the controller being configured to send a fourth drive signal to the loading system to allow the loading system to apply an axial load to the testing mechanism; and
a detection system adapted to be connected to the testing mechanism and communicatively connected to the controller, the detection system being configured to detect testing information on the testing mechanism and send the testing information to the controller.

2. The testing apparatus for the friction and wear according to claim 1, wherein the testing mechanism comprises:
a support device;
a chamber device having an end connected to the support device, the support device being configured to drive the chamber device to move in an axial direction of the chamber device;
a cooling device having an end connected to another end of the chamber device;
a drive device having an end connected to another end of the cooling device, the drive device having a rotary shaft that penetrates the cooling device and is connected to a movable ring of the chamber device, the cooling device being configured to cool the rotary shaft; and
a balance device connected to the rotary shaft and in communication with the loading system, the loading system being configured to apply an axial load to the rotary shaft by the balance device.

3. The testing apparatus for the friction and wear according to claim 2, wherein the support device comprises:
a support base;
a support frame comprising a first support portion, a second support portion, and a connection portion, wherein:
the first support portion is fixedly connected to the second support portion by the connection portion;
the first support portion has a side fixedly connected to the support base and another side connected to the chamber device; and
the second support portion is fixedly connected to the drive device.

4. The testing apparatus for the friction and wear according to claim 3, wherein the support device further comprises a slider movably arranged around an outer side wall of the connection portion and fixedly connected to the chamber device, the chamber device being movably connected to the connection portion by the slider.

5. The testing apparatus for the friction and wear according to claim 4, wherein the support device further comprises:
a lift mechanism connected between the chamber device and the first support portion and configured to drive the chamber device to move in an axial direction of the connection portion; and
a support member disposed between the chamber device and the first support portion and configured to support the chamber device.

6. The testing apparatus for the friction and wear according to claim 5, wherein the chamber device comprises:
a chamber body; and
a chamber tray connected between the chamber body and the lift mechanism and fixedly connected to the slider.

7. The testing apparatus for the friction and wear according to claim 2, wherein the lubrication system comprises a first sub-lubrication system and a second sub-lubrication system, wherein:
each of the first sub-lubrication system and the second sub-lubrication system is communicatively connected to the controller;
the first sub-lubrication system is in communication with the drive device and configured to deliver the lubrication medium to the drive device; and
the second sub-lubrication system is in communication with the chamber device and configured to deliver the lubrication medium to the chamber device.

8. The testing apparatus for the friction and wear according to claim 7, wherein the first sub-lubrication system comprises a first compression member, a first storage member, and a first lubrication device sequentially in communication with each other, wherein:
the first compression member is communicatively connected to the controller;
the first lubrication device has a medium outlet in communication with a lubrication medium inlet of the drive device; and
the first compression member is configured to drive the lubrication medium in the first lubrication device to flow into the drive device.

9. The testing apparatus for the friction and wear according to claim 7, wherein the second sub-lubrication system comprises a second compression member, a second storage member, and a second lubrication device sequentially in communication with each other, wherein:
the second compression member is communicatively connected to the controller;
the second lubrication device has a medium outlet in communication with a lubrication medium inlet of the chamber device; and
the second compression member is configured to drive the lubrication medium in the second lubrication device to flow into the chamber device.

10. The testing apparatus for the friction and wear according to claim 9, wherein the second sub-lubrication system further comprises a heating element disposed between the medium outlet of the second lubrication device and the lubrication medium inlet of the chamber device, the heating element being configured to heat the lubrication medium.

11. The testing apparatus for the friction and wear according to claim 10, wherein the second sub-lubrication system further comprises a filter member disposed between a medium inlet of the second lubrication device and a lubrication medium outlet of the chamber device, the filter member being configured to filter the lubrication medium.

12. The testing apparatus for the friction and wear according to claim 2, wherein the cooling system comprises a first sub-cooling system and a second sub-cooling system, wherein:
each of the first sub-cooling system and the second sub-cooling system is communicatively connected to the controller, and the first sub-cooling system is connected to the second sub-cooling system for heat exchange;
the first sub-cooling system is in communication with the cooling device and configured to deliver the cooling medium to the cooling device; and
the second sub-cooling system is in communication with the drive device and configured to deliver the cooling medium to the cooling device.

13. The testing apparatus for the friction and wear according to claim 12, wherein the first sub-cooling system comprises a first pump and a first circulation cooling member, wherein:
the first pump is communicatively connected to the controller, the first pump being in communication with the first circulation cooling member and a cooling medium outlet of the cooling device; and
the first circulation cooling member is in communication with a cooling medium inlet of the cooling device.

14. The testing apparatus for the friction and wear according to claim 13, wherein the second sub-cooling system comprises a second pump and a second circulation cooling member, wherein:
the second pump body, the first circulation cooling member, and the second circulation cooling member are sequentially in communication with each other to form a closed-loop flow path; and
the second circulation cooling member is in communication with each of the cooling medium inlet and the cooling medium outlet of the drive device.

15. The testing apparatus for the friction and wear according to claim 2, wherein the loading system comprises a third compression member and a third storage member, wherein:
the third compression member is communicatively connected to the controller and in communication with the third storage member; and
the third storage member is in communication with each of the balance device and the chamber device, the third compression member being adapted to apply an axial load to each of the balance device and the chamber device.

16. The testing apparatus for the friction and wear according to claim 2, wherein the detection system is connected to each of the drive device, the chamber device, and the support device, the detection system being configured to detect a vibration signal, a temperature signal, a friction force signal, an acceleration signal, a displacement signal, and a force signal of the testing mechanism, and send the detected vibration signal, the detected temperature signal, the detected friction force signal, the detected acceleration signal, the detected displacement signal and the detected force signal to the controller.
